(19) United States
(12) Patent Application Publication
(10) Pub. No.: US 2026/0329431 A1
(43) Pub. Date: Oct. 22, 2026

(54) SYSTEM AND METHOD FOR CONTROLLING A CURSOR ON A USER INTERFACE

(71) Applicant: SAMSUNG ELECTRONICS CO., LTD., Suwon-si (KR)

(72) Inventors: Sattdeepan DUTTA, Pradesh (IN); Pavan GUPTA, Pradesh (IN); Devaruppula Sai CHETHAN, Pradesh (IN); Gaurav JINDAL, Pradesh (IN)

(73) Assignee: SAMSUNG ELECTRONICS CO., LTD., Suwon-si (KR)

(21) Appl. No.: 19/699,722

(22) Filed: Jun. 5, 2026

Related U.S. Application Data
(63) Continuation of application No. PCT/KR2024/017968, filed on Nov. 14, 2024.

(30) Foreign Application Priority Data
Dec. 6, 2023 (IN) 202311083300

(51) Int. Cl. G06F 3/04892; G06F 3/04842

(52) U.S. Cl. CPC G06F 3/04892; G06F 3/04842

(57) ABSTRACT

A method and a system for controlling a cursor on a user interface. The method comprises determining user context information, acquiring past usage data corresponding to the user, and identifying target contents based on at least one of the determined user context information and the acquired past usage data. The method also includes receiving at least one user input indicating a direction of the cursor and determining a current position of the cursor. The method includes identifying a target content based on the determined current position of the cursor and a direction of the cursor indicated by the received at least one user input. The method includes controlling the cursor such that the cursor on the user interface is useable to enable the user to select the at least one identified target content using a minimum number of user input subsequent to the received at least one user input.

### CROSS-REFERENCE TO RELATED APPLICATION

This application is a continuation application, under 35 U.S.C. § 111(a), of international application No. PCT/KR2024/017968, filed Nov. 14, 2024, which claims priority under 35 U. S. C. § 119 to Indian Patent Application number 202311083300, filed Dec. 6, 2023, the disclosures of which are incorporated herein by reference in their entireties.

### TECHNICAL FIELD

The present disclosure generally relates to a field of remote control-based display devices, and more particularly relates to methods and systems for controlling a cursor on a user interface of a display device.

### BACKGROUND ART

In recent years, display devices such as smart televisions, and the like, have gained widespread popularity due to their integration of internet connectivity and advanced features. This popularity stems from their ability to stream content from various online platforms, offer interactive applications (apps), and provide seamless access to a world of entertainment and information, enhancing the overall viewing experience.

Such display devices are configured to be operated using a remote device. The remote device is provided with a remote control that acts as a crucial bridge, enabling users to navigate on-screen content displayed on a display device by manipulating a cursor, making the viewing experience more interactive and convenient. However, navigating and selecting the on-screen content using a conventional remote device can often be cumbersome and frustrating for a user which results in a bad experience. Users typically have to tediously move the cursor on the on-screen content using directional buttons of the remote device, which can be imprecise and time-consuming. This difficulty is intensified when dealing with on-screen keyboards for searches or input, making the process less user-friendly and difficult for the user.

Accordingly, there lies a need for a method and a system that can overcome at least the above challenges associated with conventional techniques of navigating and selecting the on-screen content displayed on the display device.

### DISCLOSURE

### Technical Solution

This summary is provided to introduce a selection of concepts, in a simplified format, that are further described in the detailed description of the invention. This summary is neither intended to identify key or essential inventive concepts of the invention nor is it intended for determining the scope of the invention.

According to one embodiment of the present disclosure, a method for controlling a cursor on a user interface of a display device is disclosed. The method includes determining user context information based on at least current session information involving use related to the display device by a user, a mood of the user, and an ambience of an environment of the user. The method also includes acquiring, based on the determined user context information, past usage data corresponding to the user, the past usage data including at least one of a navigation pattern of the user, a browsing history, and a usage pattern of a plurality of other users from a database. The method further includes identifying a plurality of target contents for the user based on at least one of the determined user context information and the acquired past usage data corresponding to the user. Moreover, the method includes receiving at least one user input command indicating a direction of the cursor. The method also includes determining a current position of the cursor on the user interface. Thereafter, the method includes identifying at least one first target content among the plurality of target contents based on the determined current position of the cursor on the user interface and the direction of the cursor indicated by the received at least one user input command. Furthermore, the method includes controlling the cursor on the user interface such that the cursor on the user interface is useable to enable the user to select the at least one identified first target content using a minimum number of user input subsequent to the received at least one user input.

According to another embodiment of the present disclosure, a system for controlling a cursor on a user interface for a user is disclosed. The system includes a memory and at least one processor communicably coupled with the memory. The at least one processor is configured to determine user context information based on at least current session information involving use related to the display device by a user, a mood of the user, and an ambience of an environment of the user. The at least one process is also configured to acquire, based on the determined user context information, past usage data corresponding to the user, the past usage data including at least one of a navigation pattern of the user, a browsing history, and a usage pattern of a plurality of other users from a database. The at least one processor is further configured to identify a plurality of target contents for the user based on at least one of the determined user context information and the acquired past usage data corresponding to the user. Moreover, the at least one processor is configured to receive at least one user input command indicating a direction of the cursor. Also, the at least one processor is configured to determine a current position of the cursor on the user interface. The at least one processor is further configured to identify at least one first target content among the plurality of target contents based on the determined current position of the cursor on the user interface and the direction of the cursor indicated by the received at least one user input command. Furthermore, the at least one processor is configured to control the cursor on the user interface that the cursor on the user interface is useable to enable the user to select the at least one identified first target content using a minimum number of user input subsequent to the received at least one user input.

To further clarify the advantages and features of the present invention, a more particular description of the invention will be rendered by reference to specific embodiments thereof, which are illustrated in the appended drawings. It is appreciated that these drawings depict only typical embodiments of the invention and are therefore not to be considered limiting of its scope. The invention will be described and explained with additional specificity and detail with the accompanying drawings.

### DESCRIPTION OF DRAWINGS

These and other features, aspects, and advantages of the present invention will become better understood when the following detailed description is read with reference to the accompanying drawings in which like characters represent like parts throughout the drawings, wherein:

FIG. 1 illustrates a schematic workflow of a system for controlling a cursor on a user interface for a user, according to an embodiment of the present disclosure;

FIG. 2 illustrates a schematic block diagram of the system for controlling the cursor on the user interface for the user, according to an embodiment of the present disclosure;

FIG. 3 illustrates an exemplary process flow of a method for controlling the cursor on the user interface for the user, according to an embodiment of the present disclosure;

FIG. 4 illustrates an exemplary workflow of one or more modules of the system, according to an embodiment of the present disclosure;

FIGS. 5A, 5B, 5C, 5D (FIGS. 5A-5D) illustrate graphical representations corresponding to bounded region evaluation by the system, according to an embodiment of the present disclosure;

FIGS. 6A-6B illustrate one or more positions for the cursor on the user interface, according to one or more embodiments of the present disclosure;

FIG. 7 illustrates a method of training a keystrokes estimator module, according to another embodiment of the present disclosure;

FIGS. 8A and 8B illustrates an exemplary workflow of the system, according to an embodiment of the present disclosure;

FIG. 9 illustrates an exemplary flow chart of a method for controlling the cursor on the user interface for the user, according to an embodiment of the present disclosure;

FIGS. 10A, 10B, 10C, 10D, 10G (FIGS. 10A-10G) illustrate an exemplary use case scenario of the system, according to an embodiment of the present disclosure;

FIG. 11 illustrates an exemplary use case scenario of the system during an Over-The-Top (OTT) application, according to an embodiment of the present disclosure;

FIG. 12 illustrates an exemplary use case scenario of the system during a video conference, according to an embodiment of the present disclosure;

FIG. 13 illustrates an exemplary use case scenario of the system in a metaverse environment, according to an embodiment of the present disclosure.

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having the benefit of the description herein.

### MODE FOR INVENTION

For the purpose of promoting an understanding of the principles of the invention, reference will now be made to the various embodiments and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present invention. Thus, appearances of the phrase “in an embodiment”, “in another embodiment” and similar language throughout this specification may, but do not necessarily, all refer to the same embodiment.

The terms “comprise”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components preceded by “comprises . . . a” does not, without more constraints, preclude the existence of other devices or other sub-systems or other elements or other structures or other components or additional devices or additional sub-systems or additional elements or additional structures or additional components.

Embodiments of the present disclosure are directed toward a method and a system for controlling a cursor on a user interface for a user with a minimum number of keystrokes/user inputs. The present disclosure effectively identifies user context information and moves the cursor based on the keystrokes/user inputs and the identified user context information. Specifically, a key objective of the proposed method is to control the cursor on the user interface such as to enable the user to select a target content using a minimum number of user inputs. This allows the user to navigate the cursor on the user interface quickly and easily. Moreover, the present disclosure improves an overall performance and an efficiency of a display device used to present the user interface and also enhances user experience.

The terms like “keystrokes” and “keypresses” may be used interchangeably throughout the specification.

The terms like “target content”, “target point”, “target position”, and “targets” may be used interchangeably throughout the specification.

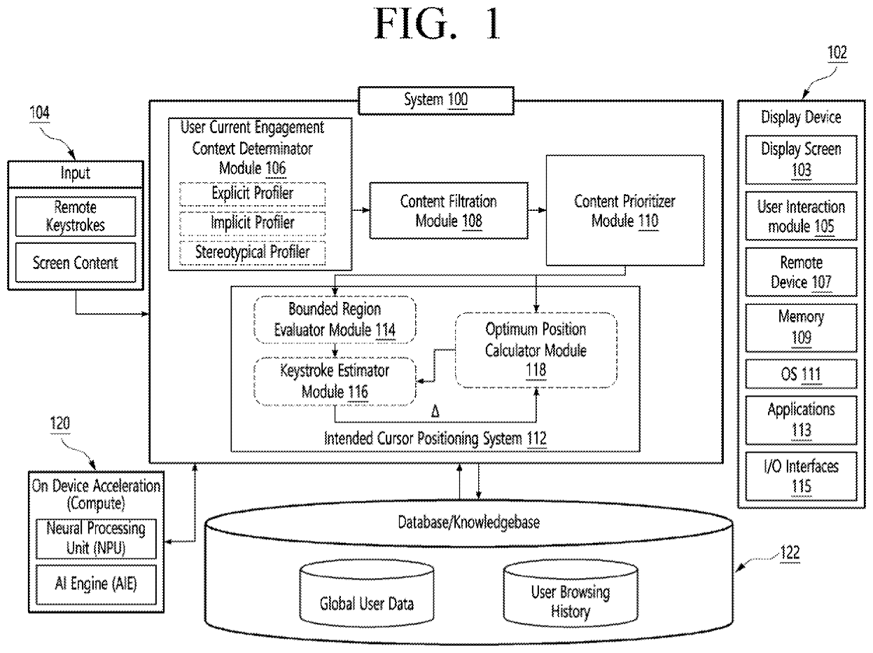

FIG. 1 illustrates a schematic workflow of a system 100 for controlling a cursor on a user interface for a user, according to an embodiment of the present disclosure. The user interface may be implemented by a display device 102. Examples of the display device 102 may include, but are not limited to, a television, a projector, a digital signage, a gaming monitor, an in-car infotainment system, a digital picture frame, an electronic whiteboard, an air-traffic control display, a point-of-sale (POS) terminal, a Light Emitting Diode (LED) display, or any other display device that may be controlled using a remote control device.

The display device 102 may include a display screen 103 configured to display media content to the user. Examples of the display screen 103 may include, but are not limited to, a light emitting diodes (LED) screen, a liquid crystal display (LCD) screen, a backlit LCD screen, an organic light emitting diodes (OLED) based screen, an electroluminescence, a plasma display panels (PDP), and the like. The display device 102 may further include a user interaction module 105 configured to enable interaction of the user with the display device 102. The user interaction module 105 may be configured to enable the user to control and access various functions and content on the display device 102. Examples of some functions and/or key components of the user interaction module 105 may include but are not limited to, a remote control interface, an on-screen display, an electronic program guide (EPG), content navigation, recommendation, parental control, and the like.

The display device 102 may be configured to be operated by a remote device 107. The remote device 107 may be a standalone device that is configured to transmit signals to the display device 102 via any of the suitable wireless and/or wired communication means. In an exemplary embodiment, the remote device 107 may be configured to enable the user to control the cursor on the user interface of the display device 102 to navigate through various content displayed on the user interface. The display device 102 may further include a memory 109 configured to store instructions/content for the operation of the display device 102. The memory 109 may include any suitable volatile and/or non-volatile memory device. The display device 102 may also include an operating system (OS) 111. The OS 111 may be implemented via the memory 109. The OS 111 may act as a core application that manages the different components and provides the user interface for controlling and accessing various functions of the display device 102. The display device 102 may include one or more applications 113 (interchangeably referred to as “the applications 113”) to enable the user of the display device 102 to access or perform desired functions/operations and perform desired functions/operations. Moreover, the display device 102 may include an Input/Output (I/O) interface 115 that includes ports and connectors to enable the user to connect external devices and interact with the display device 102. The structure and functionalities of various components 103, 105, 107, 109, 111, 113, and 115 of the display device 102 are generic and therefore a detailed explanation of such components is omitted herein for the sake of brevity of the present disclosure.

The system 100 may be communicably coupled with the display device 102. The system 100 may be a standalone device that may be communicably coupled with the display device 102. Further, the system 100 as a whole or in-part may be implemented at the display device 102. The system 100 may be configured to receive a set of inputs 104 from the display device 102. The set of inputs 104 may include remote keystrokes (may also be referred to as “user input command”) and screen content (may also be referred to as “content” and/or “media content”) being displayed on the user interface. The content may include movies, applications, music, and/or one or more activities on the display device 102.

The system 100 may include a user current engagement context determinator module 106 (may be interchangeably referred to as “the context module 106). The context module 106 may be configured to identify a current user engagement and generate a complete and consistent set of user preferences (may also be referred to as “user context information”). Further, the set of user preferences or the user context information may be updated with changes in the user's interests and inclinations. In an exemplary embodiment, the context module 106 may be configured to determine the user context information based on current session information, a mood of the user, an ambience of an environment of the user, and/or a usage history associated with the user. Specifically, the user context information may correspond to the information, data, and/or insights that help understand and measure how the user is interacting with content displayed on the display device 102. In an embodiment, the user context information may correspond to an understanding of the user's ambiance, mood, preferences, and satisfaction levels. In one embodiment, the context module 106 may be configured to determine the current context information corresponding to the user based on previously identified context information. In some embodiments, the context module 106 may include different components namely, an explicit profiler, a stereotypical profiler, and an implicit profiler, to manage different types of the context information. The explicit profiler may be configured to manage preferences/information explicitly defined by the user, for example, the user's preference such as his/her favorite genre, sports interest, and more. The stereotypical profiler may be configured to manage a set of pre-defined user stereotypes to fill in any missing preferences. Thus, the stereotypical profile may allow the user to select some stereotypes instead of manually setting every preference value. The implicit profiler may allow the system 100 to dynamically adjust to the user's changing interests by analyzing her/his watching/viewing behavior. In an exemplary embodiment, the context module 106 may be configured to output a set of user preferences based on the information provided by the different profilers.

The system 100 further includes a content filtration module 108 that may be configured to extract and store a unified (user-intended) subset of the content which the user is highly likely to choose in the current session. In an embodiment, the content filtration module 108 may be configured to identify a plurality of target contents for the user based on the determined user context information. The target contents may correspond to the content that the user is highly likely to choose in the current session. In an exemplary embodiment, the content filtration module 108 may be configured to the contents of the current screen as input along with the context information generated by the context module 106 and then filters the contents based on previous user behavior, including browsing and navigational habits, along with other similar user data stored globally. In one embodiment, the global user data i.e., the context information corresponding to the other users globally and the browsing history of the user may be stored in a database/knowledgebase 122. In particular, the content filtration module 108 may be configured to generate a set of contents from the contents of the current screen that may be the user's intended target position as an output.

Furthermore, the system 100 includes a content prioritizer module 110. The content prioritizer module 110 may be configured to assign a relevance score to the generated set of contents by the content filtration module 108 and retrieve a set of an optimal number of target content(s) that would be sufficient for recommendation purposes. Specifically, the content prioritizer module 110 may be configured to take coordinate information of the filtered set of contents with an associated user's appreciation degree and a user's current engagement context along with a current keypress direction received as the user input command. Further, based on the received information, the content prioritizer module 110 may generate the relevance score to the filtered set of target content(s) which lies in the current keypress direction.

The system 100 may further include an intended cursor positioning system 112 for controlling the cursor on the user interface for the user, in accordance with embodiments of the present disclosure. The intended cursor positioning system 112 may include a bounded region evaluator module 114 that may be configured to take the optimal number of contents and the corresponding co-ordinate information as input and output a set of bounded region(s) that will have a different relative arrangement with respect to all user's intended target contents/objects.

The intended cursor positioning system 112 may also include a keystroke estimator module 116 that may be configured to identify an optimum number of keystrokes required to reach all the user's intended targets. In one embodiment, the optimum number of keystrokes may correspond to a minimum of keystrokes required to reach all the user-intended points/content from a given point.

The intended cursor positioning system 112 may further include an optimum position calculator module 118 that is configured to predict a final position for the cursor such that all user intended target points are only optimum keystrokes away and can be reached with optimum keystrokes/user input commands.

In an embodiment, the system 100 may include an on-device acceleration system 120. The on-device acceleration system 120 may implement techniques such as, but not limited to, Natural Language Processing (NLP), Machine Learning (ML), Artificial Intelligence (AI), and the like.

In one embodiment, one or a plurality of processors may control the processing of the input data at the system 100 in accordance with a predefined operating rule or an AI model stored in a non-volatile memory and/or a volatile memory. The predefined operating rule or the AI model is provided through training or learning.

Here, being provided through learning means that, by applying a learning technique to a plurality of learning data, a predefined operating rule or AI model of the desired characteristic is made. The learning may be performed in a device itself in which AI according to an embodiment is performed, and/or may be implemented through a separate server/system.

The AI model may comprise a plurality of neural network layers. Each layer has a plurality of weight values and performs a layer operation through the calculation of a previous layer and an operation of a plurality of weights. Examples of neural networks include but are not limited to, convolutional neural network (CNN), deep neural network (DNN), recurrent neural network (RNN), restricted Boltzmann machine (RBM), deep belief network (DBN), bidirectional recurrent deep neural network (BRDNN), generative adversarial networks (GAN), and deep Q-networks.

The learning technique is a method for training a predetermined target device (for example, a robot) using a plurality of learning data to cause, allow, or control the target device to make a determination or prediction. Examples of learning techniques include, but are not limited to, supervised learning, unsupervised learning, semi-supervised learning, or reinforcement learning.

According to the disclosure, in a method for controlling the cursor on the user interface for the user, the method may include using the AI model to recommend/control the position of the cursor on the user interface. The processor may perform a pre-processing operation on the data to convert the data into a form appropriate for use as an input for the artificial intelligence model. The artificial intelligence model may be obtained by training. Here, “obtained by training” means that a predefined operation rule or artificial intelligence model configured to perform the desired feature (or purpose) is obtained by training a basic artificial intelligence model with multiple pieces of training data by a training technique. The artificial intelligence model may include a plurality of neural network layers. Each of the plurality of neural network layers includes a plurality of weight values and performs neural network computation by computation between a result of computation by a previous layer and the plurality of weight values.

Reasoning prediction is a technique of logical reasoning and predicting by determining information and includes, e.g., knowledge-based reasoning, optimization prediction, preference-based planning, or recommendation.

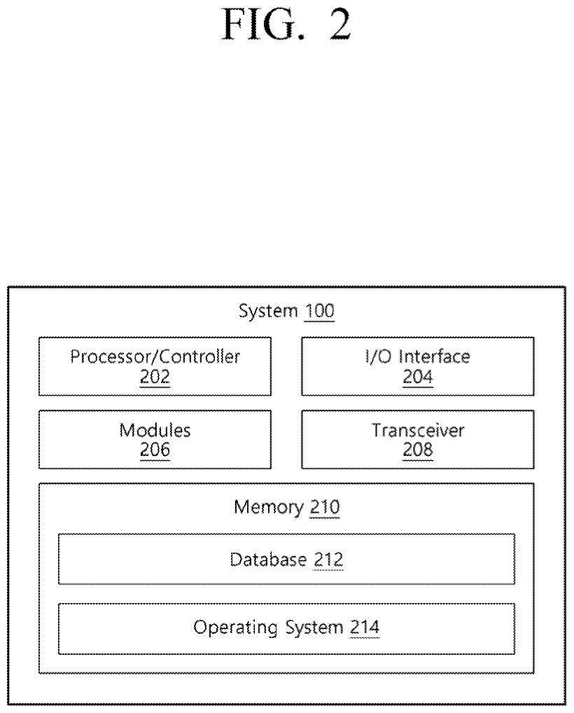

Further, a detailed explanation of various components of the system 100 has been provided in the following description in conjunction with FIGS. 2-9.

FIG. 2 illustrates a schematic block diagram of the system 100 for controlling the cursor on the user interface for the user, according to an embodiment of the present disclosure. The system 100 may be configured to reduce the number of keystrokes and/or the user input commands required to reach an intended target content on the user interface of the display device 102.

The system 100 may include a processor/controller 202, an Input/Output (I/O) interface 204, one or more modules 206, a transceiver 208, and a memory 210. In an exemplary embodiment, the processor/controller 202 may be operatively coupled to each of the I/O interface 204, the modules 206, the transceiver 208, and the memory 210. In one embodiment, the processor/controller 202 may include at least one data processor for executing processes in a Virtual Storage Area Network. The processor/controller 202 may include specialized processing units such as integrated system (bus) controllers, memory management control units, floating point units, graphics processing units, digital signal processing units, etc. In one embodiment, the processor/controller 202 may include a Central Processing Unit (CPU), a Graphics Processing Unit (GPU), or both. The processor/controller 202 may be one or more general processors, Digital Signal Processors (DSPs), Application-Specific Integrated Circuits (ASIC), Field-Programmable Gate Arrays (FPGAs), servers, networks, digital circuits, analog circuits, combinations thereof, or other now known or later developed devices for analyzing and processing data. The processor/controller 202 may execute a software program, such as code generated manually (i.e., programmed) to perform the desired operation.

The processor/controller 202 may be disposed in communication with one or more I/O devices via the I/O interface 204. The I/O interface 204 may employ communication Code-Division Multiple Access (CDMA), High-Speed Packet Access (HSPA+), Global System for Mobile communications (GSM), Long-Term Evolution (LTE), Worldwide interoperability for Microwave Access (WiMAX), or the like, etc.

Using the I/O interface 204, the system 100 may communicate with one or more I/O devices, specifically, with the display device 102. Other examples of the input device may be an antenna, microphone, touch screen, touchpad, storage device, transceiver, video device/source, etc. The output devices may be a printer, fax machine, video display (e.g., Cathode Ray Tube (CRT), Liquid Crystal Display (LCD), Light-Emitting Diode (LED), plasma, Plasma Display Panel (PDP), Organic Light-Emitting Diode display (OLED) or the like), audio speaker, etc.

The processor/controller 202 may be disposed in communication with a communication network via a network interface. In an embodiment, the network interface may be the I/O interface 204. The network interface may connect to the communication network to enable connection of the system 100 with the outside environment and/or device/system. The network interface may employ connection protocols including, without limitation, direct connect, Ethernet (e.g., twisted pair 10/100/1000 Base T), Transmission Control Protocol/Internet Protocol (TCP/IP), token ring, IEEE 802.11a/b/g/n/x, etc. The communication network may include, without limitation, a direct interconnection, Local Area Network (LAN), Wide Area Network (WAN), wireless network (e.g., using Wireless Application Protocol), the internet, etc. Using the network interface and the communication network, the system 100 may communicate with other devices.

In an exemplary embodiment, the processor/controller 202 may determine the user context information based on the current session information, the mood of the user, and the ambience of an environment of the user. The current session information may indicate contents which are currently being displayed to the user via the display device 102. The mood of the user may provide emotional cues and patterns corresponding to the user. Further, the mood of the user may be classified as positive, negative, or neutral. The ambience of the environment may indicate a type of room, lighting within the environment, a temperature of the environment, and the like.

The processor/controller 202 may also be configured to acquire past usage data corresponding to the user, the past usage data including at least one of a navigation pattern of the user, a browsing history, and a usage pattern of a plurality of other users from a database based on the determined user context information. The navigation pattern of the user may indicate how the user interacts with the contents on the user interface. For instance, the navigation pattern may indicate timings of the contents, a switching frequency of the contents, and the like. The browsing history may indicate previously accessed contents and corresponding information such as, but not limited to, a type of content, a frequency of content, a duration of content, and the like. Further, the usage pattern of the plurality of other users may also include similar information of other users as identified and/or acquired for the current user. The processor/controller 202 may also be configured to identify a plurality of target contents for the user based on the determined user context information and/or the acquired past usage data corresponding to the user. In one embodiment, the plurality of target contents may be a subset of the contents currently being displayed via the display device 102. Thereafter, the processor/controller 202 may be configured to determine the current position of the cursor on the user interface. Further, the processor/controller 202 may be configured to identify a first target content among the plurality of target contents based on the determined current position of the cursor on the user interface and the direction of the cursor indicated by the received user input command. The processor/controller 202 may be configured to control the cursor on the user interface such as to enable the user to select the identified first target content(s) using a minimum number of subsequent user input commands. In some embodiments, the processor/controller 202 may also be configured to identify one or more second target contents among the plurality of target contents based on the determined current position of the cursor and the direction of the cursor indicated by the received user input command. Further, the processor/controller 202 may be configured to identify a region on the user interface corresponding to the identified first target content(s) and the one or more identified second target contents. The processor/controller 202 may determine, based on the position coordinates of each of the first target content(s) and the one or more identified second target contents, a reference point in the identified region from which the minimum number of subsequent user input commands are required to select each of the at least one first target content and the at least one second target content. The processor/controller 202 may be configured to position the cursor at the determined reference point.

In some embodiments, the processor/controller 202 may be configured to identify a user appreciation degree corresponding to each of the plurality of target contents for the user based on the determined user context information and/or the received past usage data. The processor/controller 202 may be configured to determine a priority order of the plurality of the target contents by prioritizing at least one of the first target content(s) and the one or more identified second target contents among the plurality of the target contents based on the identified user appreciation degree. Moreover, the processor/controller 202 may be configured to determine the reference score for the at least one of the first target content(s) and the one or more identified second target contents based on the identified priority order and position the cursor at the determined reference point based on the determined reference score corresponding to the at least one of the first target content or the at least one identified second target content.

In some embodiments, the processor/controller 202 may be configured to display one or more user options to the user for the at least one identified first target content. The one or more user options may include names of the contents, and/or an option to allow the system 100 to take the cursor to a position as identified by the system 100 (i.e., take me anywhere option). The processor/controller 202 may be configured to receive a user selection to one of the one or more user options and control the position of the cursor such as to enable the user to select the one identified first target content(s) with the minimum number of subsequent user input commands.

The processor/controller 202 may implement various techniques such as, but not limited to, image processing, data extraction, Artificial Intelligence (AI), Machine Learning (ML), Deep Learning (DL), and so forth, to achieve the desired objective.

In some embodiments, the memory 210 may be communicatively coupled to the at least one processor/controller 202. The memory 210 may be configured to store data, and instructions executable by the at least one processor/controller 202. The memory 210 may communicate via a bus within the system 100. The memory 210 may include, but not limited to, a non-transitory computer-readable storage media, such as various types of volatile and non-volatile storage media including, but not limited to, Random Access Memory (RAM), Read-Only Memory (ROM), Programmable Read-Only Memory (PROM), electrically Programmable ROM, electrically erasable ROM, flash memory, magnetic tape or disk, optical media, and the like. In one example, the memory 210 may include a cache or random-access memory for the processor/controller 202. In alternative examples, the memory 210 is separate from the processor/controller 202, such as a cache memory of a processor, the system memory, or other memory. The memory 210 may be an external storage device or database for storing data. The memory 210 may be operable to store instructions executable by the processor/controller 202. The functions, acts or tasks illustrated in the figures or described may be performed by the programmed processor/controller 202 for executing the instructions stored in the memory 210. The functions, acts, or tasks are independent of the particular type of instructions set, storage media, processor, or processing strategy and may be performed by software, hardware, integrated circuits, firmware, micro-code, and the like, operating alone or in combination. Likewise, processing strategies may include multiprocessing, multitasking, parallel processing, and the like.

In some embodiments, the modules 206 may be included within the memory 210. The modules 106-118 may be a part of the modules 206. The memory 210 may further include a database 212 to store data. In an embodiment, the database 212 may include the user browsing history and the global user data. The one or more modules 206 may include a set of instructions that may be executed to cause the system 100 to perform any one or more of the methods/processes disclosed herein. The one or more modules 206 may be configured to perform the steps of the present disclosure using the data stored in the database 212, for controlling the cursor on the user interface as discussed herein. In an embodiment, each of the one or more modules 206 may be a hardware unit which may be outside the memory 210. Further, the memory 210 may include an operating system 214 for performing one or more tasks of the system 100, as performed by a generic operating system in the communications domain. The transceiver 208 may be configured to receive and/or transmit signals to and from the display device 102 associated with the user. In one embodiment, the database 212 may be configured to store the information as required by the one or more modules 206 and the processor/controller 202 to control the display device 102 in accordance with the embodiments of the present disclosure.

Further, the present invention contemplates a computer-readable medium that includes instructions or receives and executes instructions responsive to a propagated signal. Further, the instructions may be transmitted or received over the network via a communication port or interface or using a bus (not shown). The communication port or interface may be a part of the processor/controller 202 or may be a separate component. The communication port may be created in software or may be a physical connection in hardware. The communication port may be configured to connect with a network, external media, the display, or any other components in the system, or combinations thereof. The connection with the network may be a physical connection, such as a wired Ethernet connection, or may be established wirelessly. Likewise, the additional connections with other components of the system 100 may be physical or may be established wirelessly. The network may alternatively be directly connected to the bus. For the sake of brevity, the architecture, and standard operations of the operating system 214, the memory 210, the database 212, the processor/controller 202, the transceiver 208, and the I/O interface 204 are not discussed in detail.

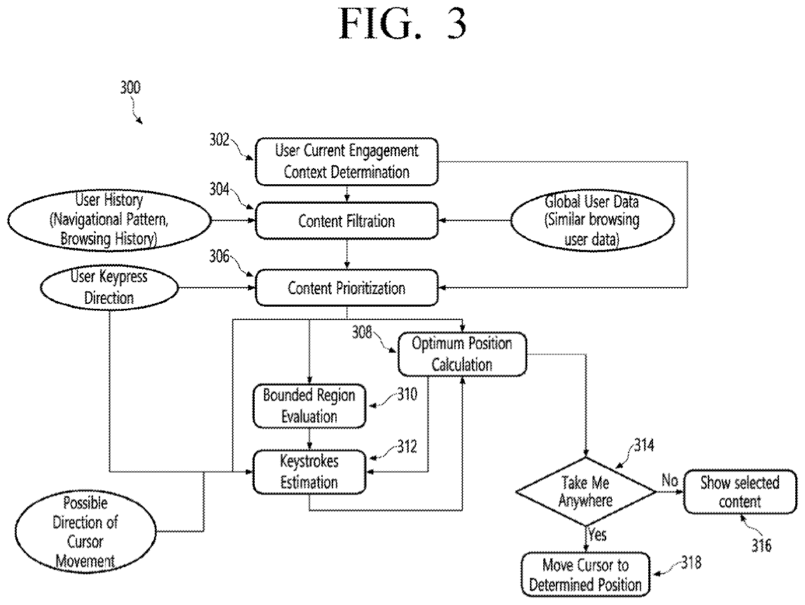

FIG. 3 illustrates an exemplary process flow of a method 300 for controlling the cursor on the user interface for the user, according to an embodiment of the present disclosure. The method 300 may be implemented by the one or more components of the system 100.

At step 302, the method 300 includes performing user current engagement context determination. The step 302 may be performed by the context module 106. The context module 106 may be configured to determine the user current engagement context that may include information, data and/or insights related to user's ambience/mood, preferences, and satisfaction levels. In particular, at step 302, the context module 106 may determine a current screen context and a current user's mood. The context module 106 may be configured to analyze various information such as, but not limited to, a user agent, a geolocation, a time zone, a language preference, cookies and local storage information, referrer information, screen dimensions, and so forth. The user agent may correspond to information related to the user's browsing application, device's operating system, and device-identification information. The geolocation may indicate the current location of the user. The time zone may correspond to the user's local time zone information which may be used to display time-sensitive information to the user. The language preference may correspond to the user's preferred language. The cookies and local storage information may correspond to small amount of data corresponding to the user that may be stored based on the usage of the display device 102. In one embodiment, the cookies and local storage information may be used to identify user preferences, maintain user sessions, and/or personalized user experience. The referrer information may indicate a previous application and/or hyperlink that leads the user to a current application and/or a webpage. The screen dimensions may indicate the user's preference for screen size, resolution, and orientation of the display device 102.

In an embodiment, the context module 106 may perform various operations such as, but not limited to, a sentiment analysis, user interaction/engagement analysis, and a facial expression analysis, to determine the user's current mood. The context module 106 and/or the implicit profiler may analyze the user-generated content such as, social media posts, content feedback, etc., to identify a current sentiment of the user. The context module 106 may monitor the interaction and engagement of the user with the content on the display device 102, to identify positive and negative engagement indicators. The positive engagement indicators may indicate a positive mood such as happiness, calmness, and relief. The negative engagement indicators may indicate a negative mood such as anger, distress, and the like. The facial expression analysis may be performed when the context module 106 has access to an imaging device connected with the display device 102. The context module 106 may analyze the facial expression of the user while viewing a content on the display device 102 to determine the user's mood. Further, the context module 106 may be configured to analyze an ambiance of the user using the imaging device and/or any other sensor device connected with the display device 102, to identify the user current engagement context.

At step 304, the method 300 includes performing content filtration. The step 304 may be performed by the content filtration module 108. The content filtration module 108 may extract and store a unified subset of content description data that would be sufficient for recommendation purposes. In particular, at step 304, the content filtration module 108 may receive the content of the current screen, and the identified user current engagement context as input and provide a set of contents that may be the user's intended target positions as output. The content filtration module 108 may utilize various user behavior-related parameters such as, but not limited to, consume, store, and an approve, to identify the desired set of content. In an embodiment, the user's action related to navigation and playback of the content is categorized under a consume category. The user's action related to storing or preserving the content is categorized under a store category. Further, the content that includes the user's annotation/comments/feedback is categorized under an approve category. In an embodiment, the content filtration module 108 may assign various weights to each of the user's action and/or behavior to determine the set of desired content. In one embodiment, the content filtration module 108 may also receive user history data including user navigation pattern, user browsing history, and other related information corresponding to the user, along with global user data including information corresponding to the other users, to determine the set of desired content for recommendation.

In an embodiment, the content filtration module 108 may be configured to assign a user appreciation degree corresponding to each of the plurality of target contents for the user based on at least one of the determined user context information and the received past usage data. The user appreciation degree may be determined using the following Equation 1:

$${R}_{d} = \frac{{\sum }_{i = 1}^{m} {c}_{i}}{{T}_{d}} + {T}_{d} \times {{\sum }^{n}}_{j = 1} {s}_{j} + {{\sum }^{p}}_{k = 1} {a}_{k} \qquad Eq . 1$$

Here, R_{d} corresponds to the user appreciation degree;
cᵢ, sⱼ, aₖ corresponds to weights of consume, store, or approve actions;
m, n, p corresponds to the numbers of actions observed on content item d for categories consume, store, and approve respectively; and
T_{d} corresponds to the duration of content item d.

At step 306, the method 300 may include performing content prioritization. The step 306 may be performed by the content prioritizer module 110. In particular, at step 306, the content prioritizer module 110 may be configured to assign a relevance score corresponding to each of the filtered content of the step 304. Specifically, the content prioritizer module 110 may be configured to receive a user input command indicating the user's current keypress direction as input and retrieve a set of an optimal number of target content(s) along with associated relevance score in the user's keypress direction.

The content prioritizer module 110 may include a classification agent and a keyword agent. The classification agent may be configured to classify the content based on a user-preferred category. In particular, the user profile may include several categories of preferences that may be represented by a genre, a channel type, a language preference, hobbies, and the like. The classification agent may classify the content based on said categories of preferences. The keyword agent may be configured to categorize the content based on text data associated with the content and user's keyword preferences. The content prioritizer module 110 may utilize a relative precision of the classification agent and the keyword agent and may update the priority of contents with time.

In some embodiments, the content prioritizer module 110 may prioritize the contents based on a corresponding relevance score which may be defined using the Equation 2:

$$R = \frac{{\sum }_{k = 1}^{n} ( {a}_{k} * {b}_{j} )}{n} \qquad Eq . 2$$

Here,
R may correspond to the relevance score to a content for a particular user in the current session;
aₖ may correspond to the weight coefficient assigned to agent k;
bᵢ may correspond to the content item rating predicted/determined in previous step 304 (i.e., Content Filtration); and
n may correspond to the total number of collaborating agents.

In an exemplary embodiment, the content prioritizer module 110 may be configured to assign a relevance score to all of the user intended filtered contents and retrieve a set of an optimal number of target content(s) in the user's keypress direction as indicated by the user input command.

The content prioritizer module 110 may be configured to utilize the classification agent and the keyword agent to add any content to the set of user intended target positions and predict the desired cursor position accurately and effectively.

At step 308, the method 300 includes performing optimum position calculation. The step 308 may be performed by the optimum position calculator module 118. The optimum position calculator module 118 may be configured to predict the optimum position for the cursor such that all user intended target objects are accessible in a minimum number of keystrokes using the corresponding coordinates along with relevance scores.

At step 310, the method 300 includes performing bounded region evaluation. The step 310 may be performed by the bounded region evaluator module 114. In particular, at step 310, the bounded region evaluator module 114 may be configured to determine unique bounded regions having different relative arrangements with respect to the user intended target object(s) on the screen using the corresponding coordinates as an input.

At step 312, the method 300 includes performing keystroke estimation. The step 312 may be performed by the keystroke estimator module 116. In particular, at step 312, the keystroke estimator module 116 may be configured to predict the minimum number of keystrokes required to access all the user-intended target object(s) in the current keypress direction for each unique bounded region received from previous step 310 using all possible direction of cursor movement and the relevance score of the intended target(s) and identifying the bounded region with minimum keystrokes. Further, the method 300 may include back-propagating to step 308 based on a difference between the number of keystrokes required to access the user-intended target objects estimated by 312 for the predicted cursor position obtained from 308 and the minimum number of keypresses obtained amongst all the bounded regions received from 310. In an exemplary embodiment, the keystroke estimator module 116 may be configured to assist the optimum position calculator module 118 to predict a position (x, y) from which all the user-intended target points can be reached in the optimum keystrokes. In an embodiment, the keystrokes estimator module 116 may determine keystrokes for every bounded region based on the relevance score obtained from the content prioritizer module 110.

In one embodiment, the keystroke estimator module 116 may take the coordinates of “n” number user intended target contents (x, y), the total number of possible directions for cursor movement (k), the current keypress direction, the relevance score for all the target content along with the set unique bounded region determined by the bounded region evaluator module 114 i.e. coordinated set A {A1, A2, . . . , An}, as input, to determine a set of the predicted number of keystrokes (Ci) required to reach to all user intended target positions from every unique bounded region i.e.,

Ci∀Ai∈{A1, A2, . . . , An}

Using this set of Costs Obtained for every bounded region i.e., the optimum position calculation module is back propagated with the difference in Cost of position predicted by optimum position calculation module and the minimum Costs obtained amongst bounded region i.e. min ({C1, C2, . . . , Cn}∀Ai∈{A1, A2, . . . , An}).

At step 314, the method 300 may include determining whether the user has selected an option “take me anywhere” that allows the system 100 to move the cursor at an identified position/determined reference position in the bounded region.

Upon determining that the user has selected the “take me anywhere” option, the system 100 may move the cursor to the determined reference position, as shown by step 318.¬

Upon determining that the user has a selected a target content instead of the “take me anywhere” option, the system 100 may move the cursor to show the selected target content, as indicated by step 316.

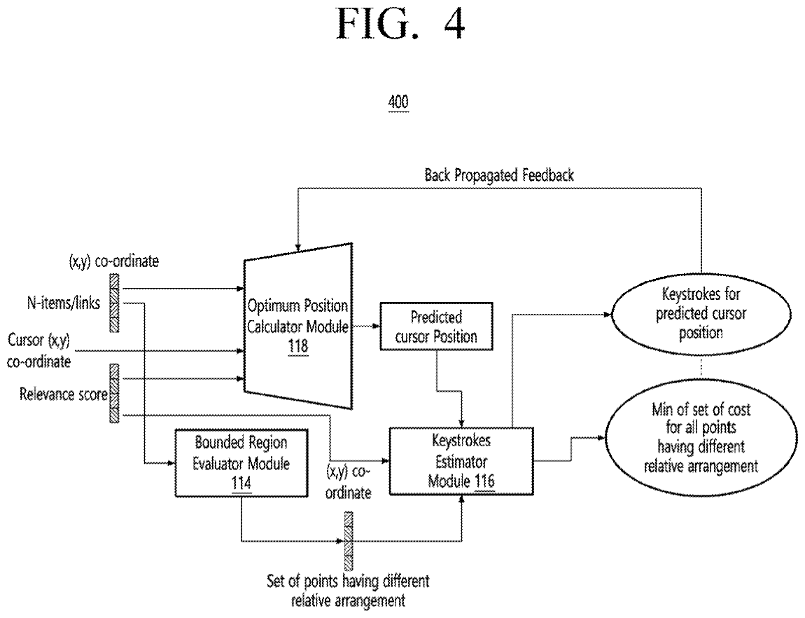

The steps 308-312 may further be explained in references to FIGS. 4-8.

FIG. 4 illustrates an exemplary workflow of one or more modules of the system 100, according to an embodiment of the present disclosure. In particular, FIG. 4 illustrates operations of the optimum position calculator module 118 in conjunction with the bounded region evaluator module 114 and the keystroke estimator module 116.

The optimum position calculator module 118 may be configured to predict a next cursor position that would be minimum keystrokes away to the optimum set of user-intended targets object(s) obtained from the last step. To make the prediction, the optimum position calculator module 118 may take (x, y) coordinates of all the user-intended target object/content(s) including the relevance score assigned to each of the user-intended target content(s) and current cursor coordinates, as input. Given these inputs, the optimum position calculator module 118 may predict the next position or a next (x, y) coordinate for the cursor that would require the least keystrokes to reach all user-intended target contents using the difference in keystrokes between the predicted output and the ground truth which is obtained with the help of the bounded region evaluator module 114 and the keystroke estimator module 116.

To calculate the ground truths, the optimum position calculator module 118 may be configured to obtain a set of bounded regions with respect to the positioning of the targets. The bounded regions are decided such that all the regions will have unique relative arrangements with respect to all user intended target object(s) and the set of all such bounded regions should consider all the possible relative arrangements of the target contents.

Further, for all the unique bounded regions obtained previously, the keystroke estimator module 116 may be configured to calculate overall keystrokes required to reach all target contents based on a probability of reaching a target from a source position using a specified direction for all unique bounded regions using the relevance score of the user intended target object(s).

Moreover, based on the difference between the minimum overall keystrokes obtained for all uniquely identified bounded regions and the keystrokes required from the predicted cursor position, the optimum position calculator module 118 is back propagated and the next cursor position is updated accordingly.

In one embodiment, the optimum position calculator module 118 may be defined by the expression p(S, T, R). Here, S may correspond to a source position, T may correspond to a set of user-intended target points, and R may correspond to the relevance ratio of the user-intended target point. Further, the expression p(S, T, R) may be defined as:

p(S,T,R)={position (x,y) having optimum keystrokes}

Further, the keystroke estimator module 116 may be defined by the expression f(S, T, R, C), wherein the expression f(S, T, R, C) may be defined as:

f(S,T,R,C)={overall number of keystrokes from S (src) to T (destn)}

Here, C may correspond to a set of clusters in a particular direction.

The optimum position calculator module 118 may be trained using the following steps.

The following assumptions may be made to train the optimum position calculator module 118:

Let {xᵢ, yᵢ} be the set of co-coordinates of the user-intended objects in the display area. Let {Rᵢ} be the relevance score of these objects and let (x_{c}, y_{c}) be the coordinates of the current cursor position. There are finite bounded regions, {Bᵢ} such that the relative arrangement of user-intended objects with respect to a given Bᵢ is unique. Further, the keystroke estimator module 116 is already trained.

Further, the following inferences are made based on the above assumptions:

Selecting the next cursor position on selecting a given direction ‘K’ is dependent on the relative arrangement of the user-intended objects in that direction along with the probability of reaching a user-intended object using the specified set of directions. Also, the number of key presses required to reach the user-intended objects is the same for all the points in a given bounded region Bᵢ.

The optimum position calculator module 118 may trained with the objective to find the target cursor position (xₚ, xₚ) such that the number of keypresses required to reach to the user-intended objects is minimum with respect to all the possible points in the display area. Since the number of keypresses required to reach the user-intended objects is the same for all the points belonging to a bounded region (bᵢ). Therefore, the objective function of the optimum position calculator can be optimized as:

Finding the target cursor position (xₚ, xₚ) such that the output of the keystroke estimator with respect to the predicted cursor position is same as the minimum of keystroke estimator output with respect to all the elements in the set {Bᵢ}. In an embodiment, a cross entropy of the above values may be provided as feedback to the optimum position calculator module 118.

In an embodiment, a loss function of the optimum position calculator module 118 may be defined by Eq. 3:

Δ=log(f(p(S′,T′,R′),T,R,C)−min(f({Bi,}T,R,C) Eq. 3

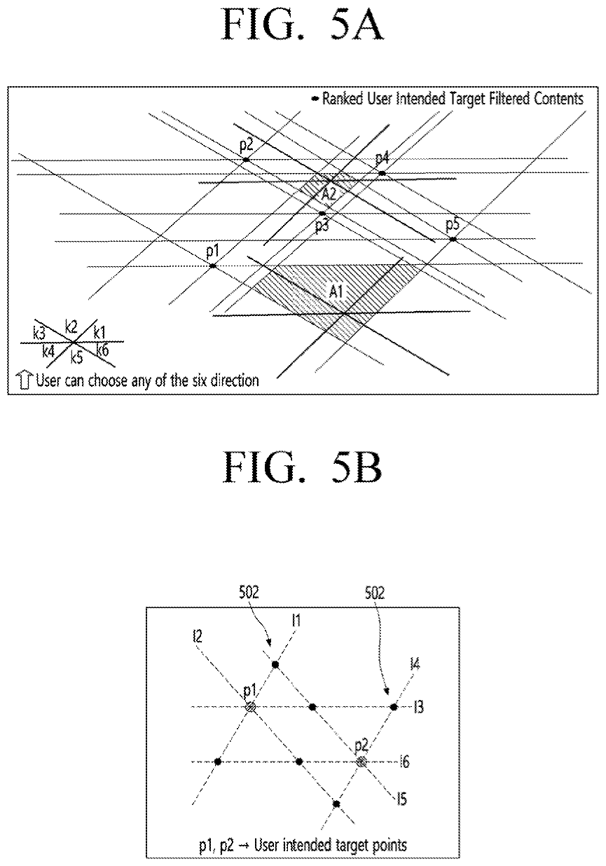

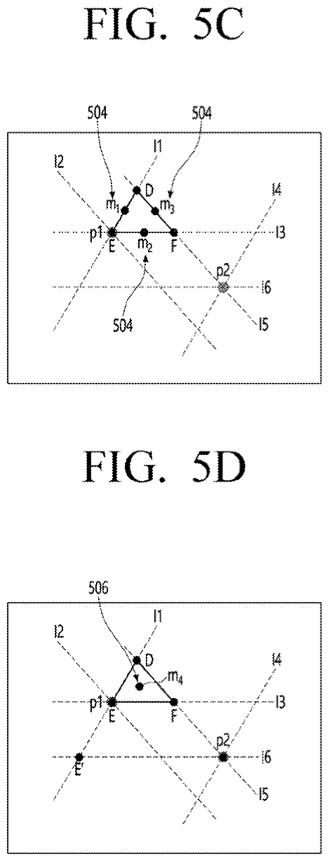

FIGS. 5A-5D illustrate graphical representations corresponding to bounded region evaluation by the system 100, according to an embodiment of the present disclosure.

The bounded region evaluator module 114 may be configured to identify optimum overall keystrokes required to reach all the user intended targets needs to consider all the bounded regions having different relative positions with respect to all the intended target positions. The bounded region evaluator module 114 may be configured to take (x, y) coordinates of all user-intended target filtered contents on the screen {i.e., p₁, p₂, p₃, p₄, p₅} as input and provide a coordinated set A {i.e., A₁ A₂, . . . , Aₘ} of bounded regions, as output, as illustrated in FIG. 5A.

Further, all the bounded regions in the set A may have different relative arrangements with respect to all the user-intended target positions considering all the possible directions. The bounded region evaluator module 114 may each bounded region with “k” possible direction of the cursor. The bounded region evaluator module 114 may configured to determine the unique set of points that have different relative arrangements with respect to the user-intended target positions. In an embodiment, the bounded region evaluator module 114 may be configured to identify all the lines passing through a target point in all “k” direction and determine the bounded region formed by intersection of said lines, as illustrated in FIG. 5A. In case, there are ‘n’ number of points, and ‘k’ different direction, a total number of lines that needs to be considered by the bounded region evaluator module 114 may be equal to (n*k/2).

Moreover, all the edges, corners, and closed bounded areas may have different relative arrangements with respect to the user-intended target positions as the number of target points may be different in each possible direction for the edges, the corners, and the closed bounded areas. Thus, the bounded region evaluator module 114 may consider each of the edges, the corners, and the closed bounded areas to determine the optimum keystrokes to reach all the user-intended target positions.

FIG. 5B illustrates corners 502 as identified by the bounded region evaluator module 114. In an embodiment, the bounded region evaluator module 114 may select two non-parallel lines among (n*k/2) lines passing through all the user intended target points and determine the corners 502 may be equal to (^{n*k2}C2). For instance, for six different directions, and two user-intended target points, the total number of lines may be (6*2/2)=6 {I1, I2, I3, I4, I5, I6}, as shown in FIG. 5B. The bounded region evaluator module 114 may then select any 2 lines amongst (^{n*k2}C2) lines. For instance, the equations of said two non-parallel lines are a₁x+b₁y+c₁=0 and a₂x+b₂y+c₂=0. The bounded region evaluator module 114 may solve the above equations corresponding to said two non-parallel lines to identify the corners 502.

FIG. 5C illustrates edges 504 as identified by the bounded region evaluator module 114. In an embodiment, the bounded region evaluator module 114 may select more than two non-parallel lines among lines passing through all the user-intended target points and to identify a bounded region. The bounded region may have an equal number of edges as the number of non-parallel lines used to define the bounded region. For example, if the bounded region evaluator module 114 selects three non-parallel lines, the number of identified edges 504 will equal to three, for example, m1, m2, and m3.

FIG. 5D illustrates a closed bounded region 506 as identified by the bounded region evaluator module 114. For instance, the bounded region evaluator module 114 may select three lines to identify the closed bounded region 506. The closed bound region 506 may have same relative arrangement for each of the user-intended target points. Therefore, the bounded region evaluator module 114 may be identify a centroid m4, as a representative of all of the points lying within the closed bounded region 506. Further, while selecting the closed bounded region 506, the bounded region evaluator module 114 may discard the bounded regions that include any of the corners, and the edges as already identified by the bounded region evaluator module 114. For instance, if the bounded region evaluator module 114 selects line 11, 16, and 15, a closed bounded region ΔDE′p₂ is formed, however as m2 (as shown in FIG. 5C) an edge, which has already been identified lies within the closed bounded region ΔDE′p₂ the closed bounded region ΔDE′p₂ may be discarded by the bounded region evaluator module 114.

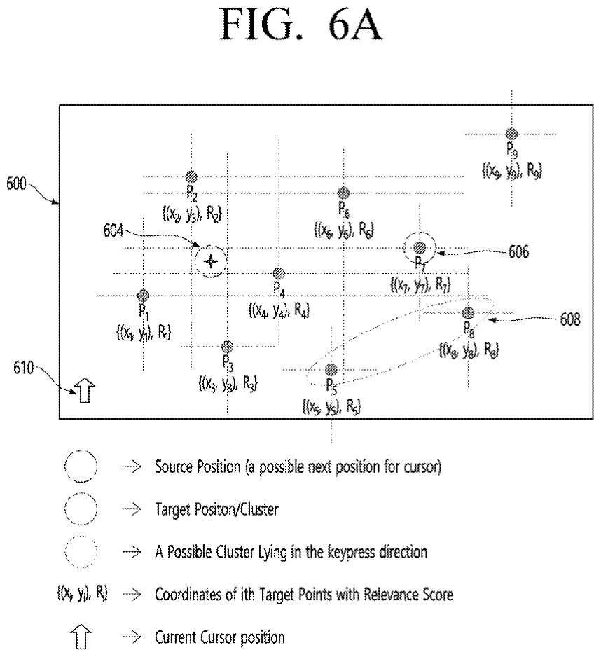

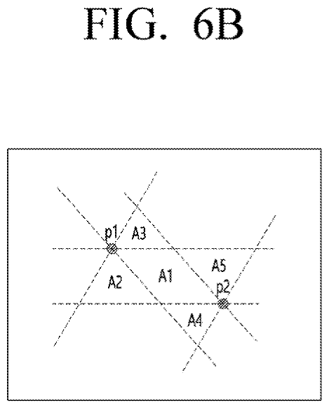

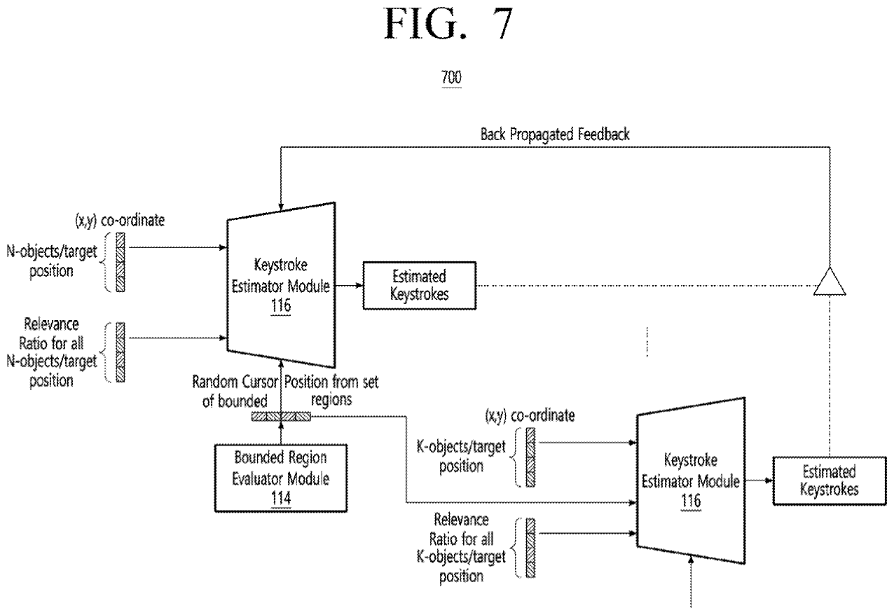

FIGS. 6A-6B illustrate one or more position for the cursor on the user interface 602, according to one or more embodiments of the present disclosure. In an embodiment, every bounded region may have different probability of selecting a specified direction. The keystroke estimator module 116 may be configured to determining the probability of choosing any direction amongst {k₁, . . . , kₙ} based on a total number of the user-intended target contents within that specifying direction.

The probability of the user's selection of any direction in any bounded region amongst {k₁, . . . , kₘ}, (Xₖ) may be defined by Eq. 4:

$${X}_{k} = {\sum }_{i = 1}^{{n}^{′}} ri \qquad Eq . 4$$

Here, rᵢ may correspond to a relevance ratio of i^{th} user-intended target content, and “n” may correspond to a number of the user-intended target contents within the user-selected direction. In some embodiments, the keystroke estimator module 116 may be configured to multiply the overall keypresses with the probability of getting said keypresses to reach all user-intended target points to determine the minimum number of keypresses to each the user-intended target. In FIG. 6A, points P1-P9 are the user-intended target points. Further, point 604 may indicate the source position of the cursor. Point 606 may indicate the target position of the cursor. A shape 608 may correspond to a possible cluster within the keypress direction. Further, an arrow 610 may represent the current position of the cursor.

In an embodiment, a minimum number of keypresses/keystrokes (f(S, T, R, C)) required to reach the target cluster or a target point from a given source point may be defined by Eq. 5:

$$f ( S , T , R , C ) = {\sum }_{d = 1}^{K} Xd * \{ {\sum }_{j = 1}^{N} f ( Si , {Tj}^{′} , {R}^{′} , {C}^{′} ) \} \qquad Eq . 5$$

Here S may correspond to a source position, T may correspond to a target cluster, R may correspond to a relevance ratio, and C may correspond to a set of all cluster lying in that particular direction.

Further, Xd may correspond to the probability of selecting the d^{th} direction from current position, K may correspond to the total number of directions, and N may correspond to the total Number of points lying in the d^{th} direction.

In one embodiment, function f(S, T, R, C) may converge when {C} have only two elements i.e., in case there are two actionable item, the distance may be 1. i.e., f(S,T,R,C)=1 when we have only two target positions

For instance, in FIG. 6B, selecting any point among {A1, . . . . A5} may cost as 1 to reach either p1 or p2 (base case).

FIG. 7 illustrates a method of training the keystroke estimator module 116, according to an embodiment of the present disclosure.

The following assumptions are made to train the keystroke estimator module 116:
(xᵢ, yᵢ} be the set of co-coordinates of the user-intended objects in the display area.
{Rᵢ} be the relevance score of these objects and let (x_{c}, y_{c}) be the coordinates of the current cursor position.

There are finite bounded regions, {Bᵢ} such that the relative arrangement of user-intended objects with respect to a given Bᵢ is unique.

Assuming that a point has no relevance, which lies outside the scope of given direction.

The keypress estimator module 116 may be a recursive function which is defined as:

$$f ( S , T , R , C ) = {\sum }_{d = 1}^{K} Xd * \{ {\sum }_{j = 1}^{N} f ( Si , {Tj}^{′} , {R}^{′} , {C}^{′} ) \}$$

Further, the following inferences are made to train the keystroke estimator module 116. The keystroke estimator module 116 is a recursive function, therefore the number of keystrokes required for reaching ‘n’ user-intended target position with a given relative arrangement may be derived from a combination of a smaller subset of user-intended target positions in each direction. Thus, the keystroke estimator module 116 may be progressively trained by providing the number of keystrokes for all smaller subsets in the same relative arrangement as ground truth.

Moreover, the keystroke estimator module 116 may be trained with the following objective:

Given a source point (x_{c}, y_{c}), and a set of user-intended targets with a given relative arrangement and relevance (R), the objective of the keystroke estimator module 116 may be to find the number of keypresses required when an additional set of ‘k’ user-intended targets are added to the display area. The difference in the predicted output and ground truth created using a combination of smaller subsets of user-intended targets for k points (k<N) can be back propagated to the module.

Therefore, a loss function for keystroke estimator module 116 at n^{th} step may be defined as:

$$Δ = log ( fn ( S , T , R , C ) - {\sum }_{d = 1}^{K} Xd * \{ {\sum }_{j = 1}^{c} fj ( Si , {Tj}^{′} , {R}^{′} , {C}^{′} ) \} )$$

Here, c may correspond to the number of clusters within a specific direction.

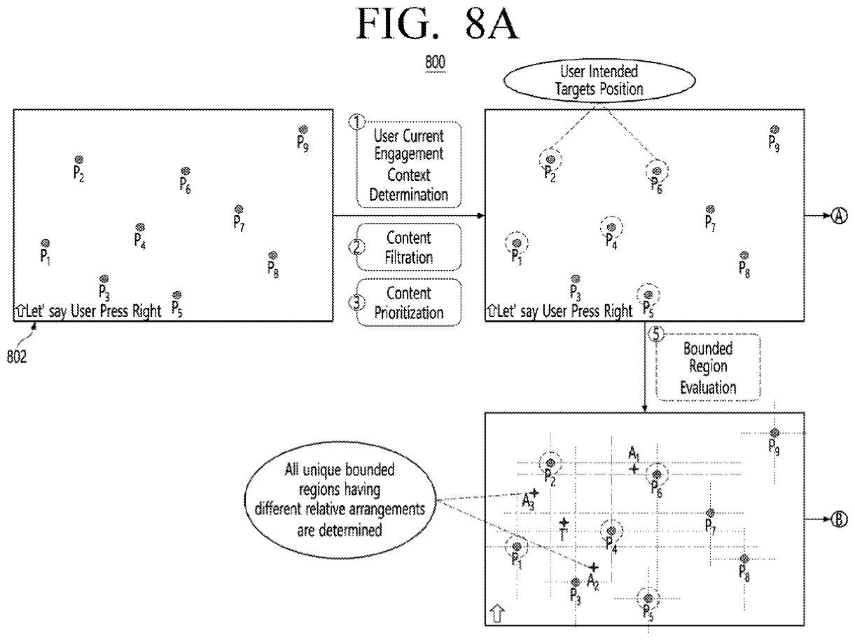

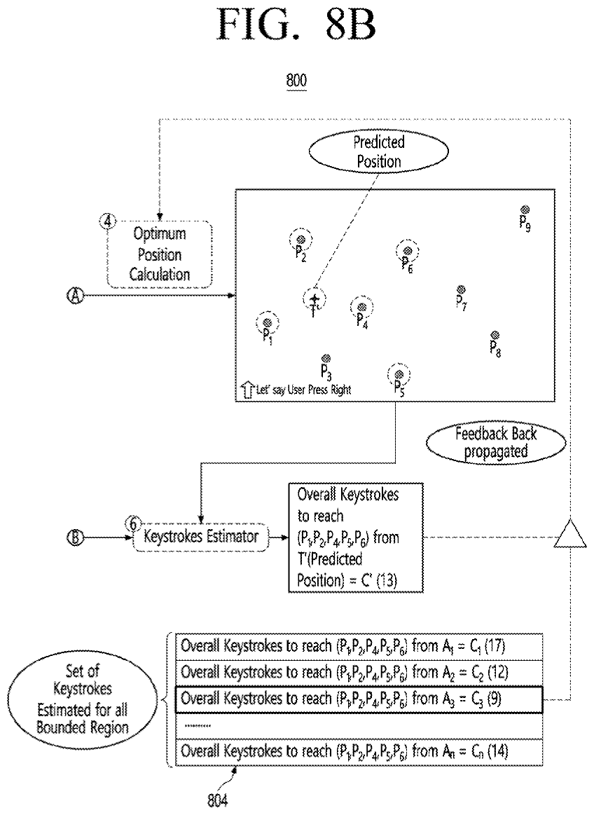

FIGS. 8A and 8B illustrates an exemplary workflow of the system 100, according to an embodiment of the present disclosure. In the illustrated embodiment, {P₁, P₂, . . . , P₉} are the user-intended target points. Here, it is assumed that the user's keystroke corresponds to a “Right” direction. Based on a current position 802 of the cursor, the system 100 may identify that all the user-intended target points lies within the same direction. Therefore, the system 100 may obtain a set of optimum user-intended target positions {P1, P2, P4, P5, P6}.

Further, the system 100 may utilize the optimum position calculator module 118 to determine the intended cursor position (T′), and the number of keystrokes required to navigate to the intended positions {P1, P2, P4, P5, P6} is determined using the keystroke estimator module 116.

Moreover, the system 100 may utilize the bounded region evaluator module 114 to determine all the set of regions that have different relative arrangements with respect to all the points lying in the right direction i.e. {P1, P2, . . . , P9}, all bounded regions. (For. Ex. A1, A2, A3 have different relative arrangement).

The system 100 then utilizes the keystroke estimator module 116 to determine the number of keystrokes required to navigate to the user-intended objects in all the bounded regions.

Further, a difference in the minimum of keystrokes in the bounded regions and the number of keystrokes as initially identified by the keystroke estimator module 116 is determined to back propagate to the keystroke estimator module 116.

The various set of keystrokes estimated for all the bounded regions is identified as Table 804.

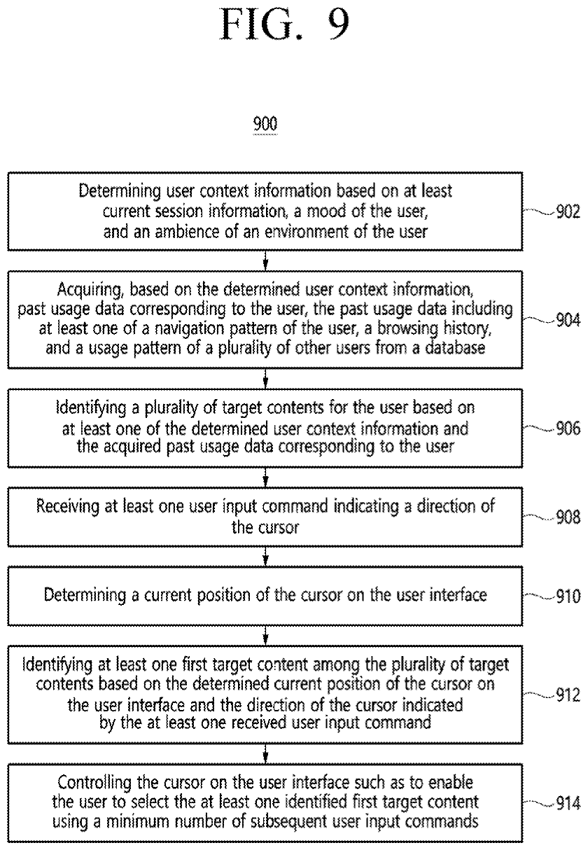

FIG. 9 illustrates an exemplary flow chart of a method 900 for controlling the cursor on the user interface for the user, according to an embodiment of the present disclosure. The method 900 may be implemented by one or more components of the system 100.

At step 902, the method 900 includes determining user context information based on at least current session information, a mood of the user, and an ambiance of an environment of the user.

At step 904, the method 900 includes acquiring, based on the determined user context information, past usage data corresponding to the user, the past usage data including at least one of a navigation pattern of the user, a browsing history, and a usage pattern of a plurality of other users from a database.

At step 906, the method 900 includes identifying a plurality of target contents for the user based on at least one of the determined user context information and the acquired past usage data corresponding to the user.

At step 908, the method 900 includes receiving at least one user input command indicating a direction of the cursor. Next at step 910, the method 900 includes determining a current position of the cursor on the user interface.

At step 912, the method 900 includes identifying at least one first target content among the plurality of target contents based on the determined current position of the cursor on the user interface and the direction of the cursor indicated by the at least one received user input command.

At step 914, the method 900 includes controlling the cursor on the user interface such as to enable the user to select the at least one identified first target content using a minimum number of subsequent user input commands.

The method 900 may also include identifying at least one second target content among the plurality of target contents based on the determined current position of the cursor and the direction of the cursor indicated by the at least one received user input command. The method 900 may further include identifying a region on the user interface corresponding to the at least one identified first target content and the at least one identified second target content. Moreover, the method 900 may include determining, based on position coordinates of each of the at least one identified first target content and the at least one identified second target content, a reference point in the identified region from which the minimum number of subsequent user input commands is required to select each of the at least one first target content and the at least one second target content. Also, the method 900 may include positioning the cursor at the determined reference point.

In one embodiment, the method 900 may include identifying a user appreciation degree corresponding to each of the plurality of target contents for the user based on at least one of the determined user context information and the received past usage data. Further, the method 900 may include determining a priority order of the plurality of the target contents by prioritizing at least one of the first target content or the at least one identified second target content among the plurality of the target contents based on the identified user appreciation degree. Next, the method 900 may include determining the reference score for the at least one of the first target content or the at least one identified second target content based on the identified priority order. Furthermore, the method 900 may include positioning the cursor at the determined reference point based on the determined reference score corresponding to the at least one of the first target content or the at least one identified second target content.

In some embodiments, the method 900 may include displaying one or more user options to the user for the at least one identified first target content. The method 900 may also include receiving a user selection to at least one of the one or more user options. Next, the method 900 may include controlling the position of the cursor such as to enable the user to select the at least one identified first target content with the minimum number of subsequent user input commands.

Embodiments as discussed above are exemplary in nature and the method 900 may include any additional step to perform the desired objective of the present disclosure. Further, the steps of the method 900 may be performed in any suitably manner in order to achieve the desired advantages.

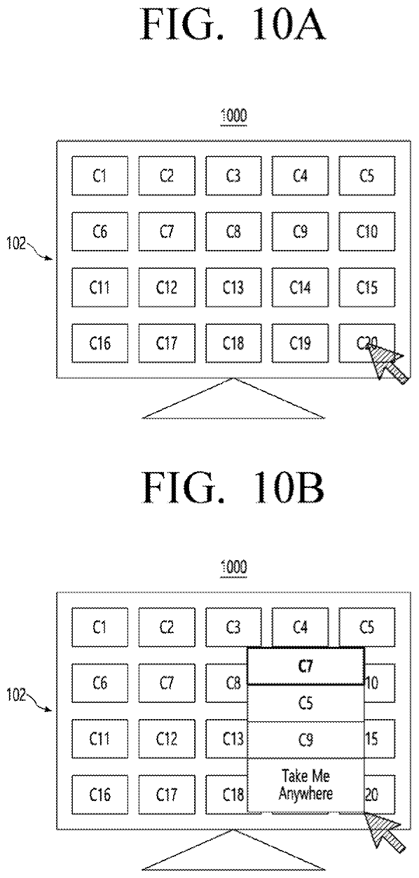

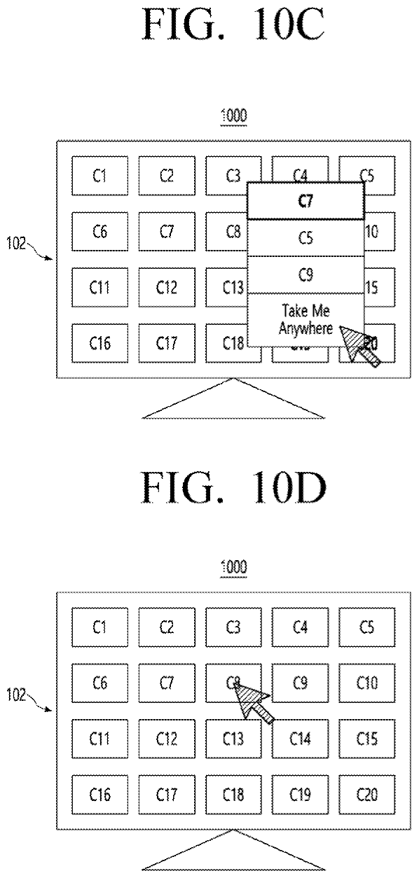

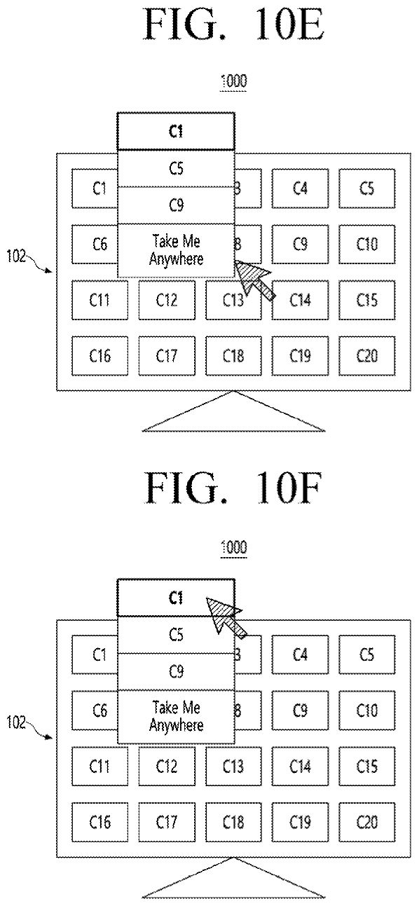

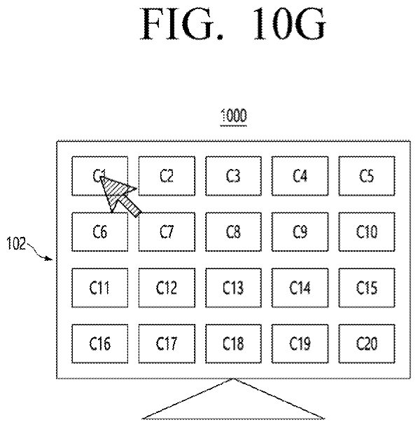

FIGS. 10A-10G illustrate an exemplary use case scenario 1000 of the system 100, according to an embodiment of the present disclosure. FIG. 10A illustrates that the currently there are twenty content (i.e., C1-C20) are being displayed via the user interface of the display device 102. Further, the current position of the cursor on the user interface is at content C20. Next, FIG. 10B illustrates that on a user input command indicating a “Left” direction of the cursor, the system 100 may display one or more suggestions to the user. Specifically, the system 100 may query the user if he/she wishes to directly move to a target content as identified by the system 100, as discussed above, or he/she wishes to allow the system 100 to move the cursor to a reference position with a “take me anywhere” option such that all the user's intent content can be accessed with minimum number of user input commands. FIG. 10C illustrates that the user has selected the take me anywhere option. FIG. 10D illustrates that on the selection of the “take me anywhere” option, the system 100 moves the cursor to the reference position identified based on the user current engagement context and current content on the screen. In the illustrated embodiment, the reference position is at the content C8. Further, the user provides the user command input as “UP” direction. The system 100 may further provide one or more suggestions to the user based on the received user command input, the user current engagement context, and the current content, as shown by FIG. 10E. FIG. 10F illustrates the user selects one of the content from the one or more suggestions, i.e., content C1. Next, FIG. 10G illustrates, the system 100 moves the cursor directly to the content C1. Thus, the user reaches content C20 to C1 within minimum user command inputs i.e., just two direction inputs and two selections. Therefore, the system 100 reduces the user's effort to navigate from one content to another and enhances user experience of the display device 102.

In some embodiments, the content may correspond to various applications and/or websites. Example of such applications and/or website may include, but not limited to, video streaming applications, browsing websites, e-commerce websites, over-the-top (OTT) applications, and the like. In another embodiments, the content may correspond to various sections on a website or an application. For example, the content may correspond to a search section, a payment section, a catalogue section, and/or a specific product on a webpage and/or a user interface of an application.

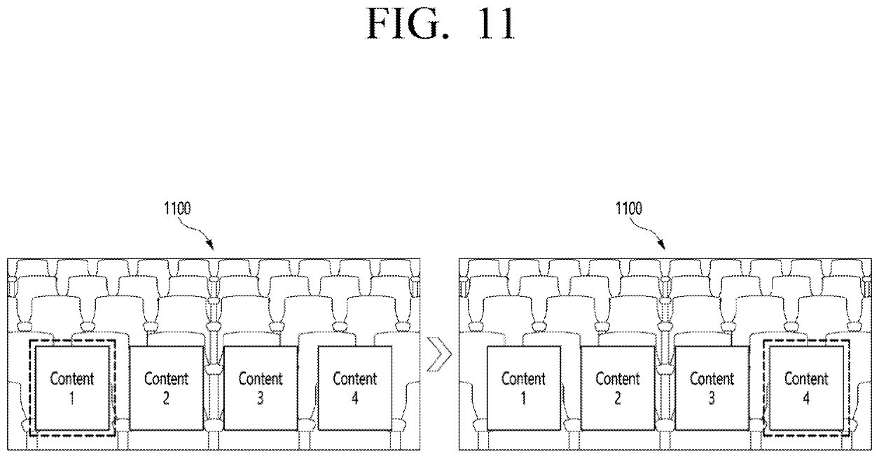

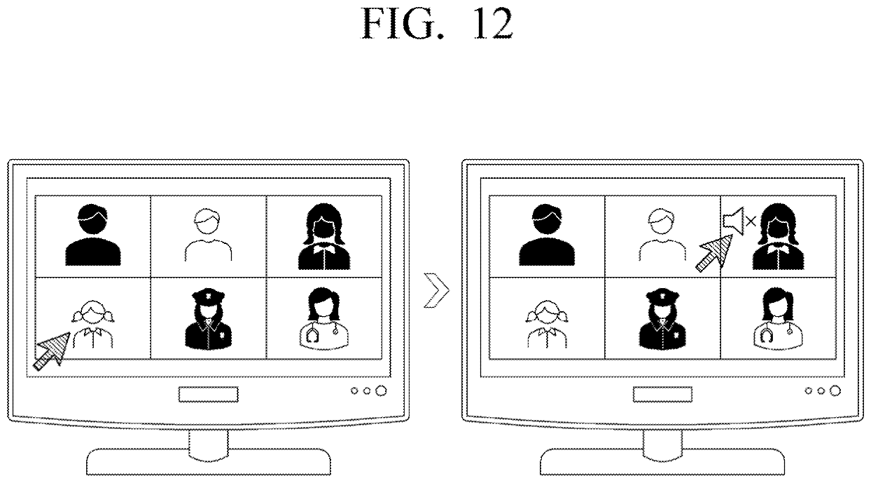

The system 100 may also reduce the user′ efforts while accessing features of the display device 102, for example, scheduling a reminder, recording a program, and so forth. FIG. 11 illustrates an exemplary use case scenario of the system during an Over-The-Top (OTT) application 1100, according to an embodiment of the present disclosure. In this scenario, the user selection is at “content 1”, and the user has pressed “right” directional key. The system 100 may identify based on user-related information and/or received user input as the press on “right” directional key that the user is most likely to select “content 4”. Therefore, instead of taking the selection to “content 2”, “content 3”, the system 100 may directly take the selection to “content 4”. Thus, the system 100 may enhance user experience by reducing the number of keystrokes required to reach the “content 4”.

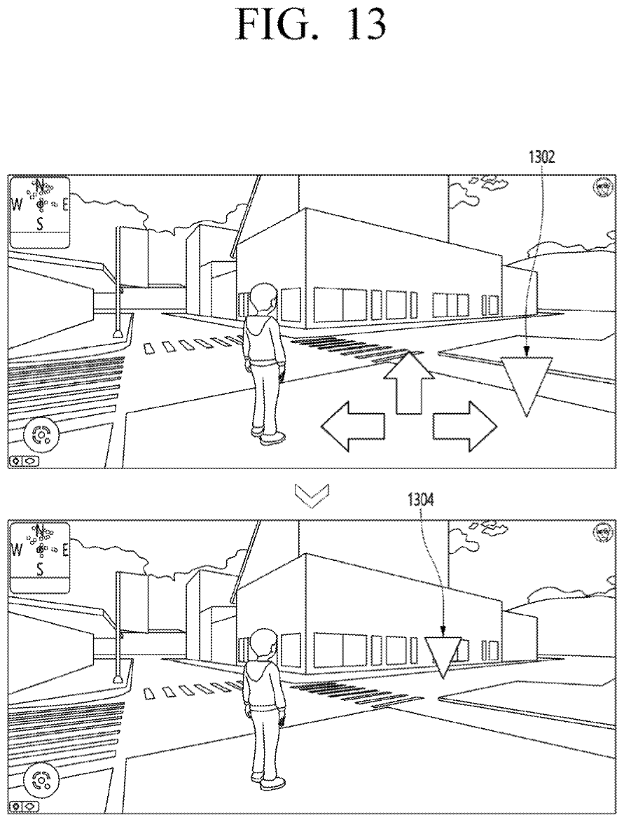

FIG. 12 illustrates an exemplary use case scenario of the system during a video conference, according to an embodiment of the present disclosure.

In particular, the system 100 may be implemented during the live video conference, where upon determining a disturbance from one of the participant and received user input command directing towards that participant, the system 100 may directly move the cursor from a left most corner to that participant to allow the user to mute the participant. In particular, the system 100 may identify a participant whose microphone is activated and therefore the system 100 directly takes the cursor over that participant to allow a host to mute that participant. Thus, the system 100 saves time and provides an effective communication between the user and the participants.

FIG. 13 illustrates an exemplary use case scenario of the system 100 in a metaverse environment, according to an embodiment of the present disclosure. Particularly, the system 100 may be implemented in the metaverse environment, as illustrated in FIG. 13. Further, on receiving a user input command, the system 100 may take the user and/or an indicator to a nearest place in the metaverse environment where the user is most likely to visit in a direction as indicated by the user input command. For instance, the user's current position in the metaverse environment is at a position 1302, and when the user presses “UP” key, the system 100 may identify a position 1304 corresponding to a club as the intended user position, therefore the system 100 may take the user directly to the position 1304. This may reduce repetitive user inputs and/or user movement in the metaverse environment.

The present disclosure therefore reduces exertion required for the user to explore through the displayed contents on a display device. Further, the present disclosure provides easy accessibility to target contents by redefining the layout of the contents on the display device.

While specific language has been used to describe the present subject matter, any limitations arising on account thereto, are not intended. As would be apparent to a person in the art, various working modifications may be made to the method in order to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment.

1. A method for controlling a cursor on a user interface of a display device, the method comprising:
determining user context information based on at least current session information involving use related to the display device by a user, a mood of the user, and an ambiance of an environment of the user;
acquiring, based on the determined user context information, past usage data corresponding to the user, the past usage data including at least one of a navigation pattern of the user, a browsing history, and a usage pattern of a plurality of other users from a database;
identifying a plurality of target contents for the user based on at least one of the determined user context information and the acquired past usage data corresponding to the user;
receiving at least one user input indicating a direction of the cursor;
determining a current position of the cursor on the user interface;
identifying at least one target content among the plurality of target contents based on the determined current position of the cursor on the user interface and the direction of the cursor indicated by the received at least one user input; and
controlling the cursor on the user interface such that the cursor on the user interface is useable to enable the user to select the identified at least one target content using a minimum number of user input subsequent to the received at least one user input.

2. The method as claimed in claim 1, wherein the identified at least one target content is at least one first target content and the method comprises:
identifying at least one second target content, among the plurality of target contents, based on the determined current position of the cursor and the direction of the cursor indicated by the received at least one user input;
identifying a region on the user interface corresponding to the at least one first target content and the identified at least one second target content;
determining, based on position coordinates of the identified at least one first target content and the identified at least one second target content, respectively, a reference point in the identified region from which the minimum number of user input subsequent to the received at least one user input is required to respectively select the at least one first target content and the at least one second target content; and
positioning the cursor at the determined reference point.

3. The method as claimed in claim 2, wherein controlling the cursor on the user interface comprises:
identifying a user appreciation degree corresponding to the plurality of target contents, respectively, for the user based on at least one of the determined user context information and the acquired past usage data;
determining a priority order of the plurality of target contents by prioritizing the at least one of the first target content or the at least one identified second target content among the plurality of target contents based on the identified user appreciation degree;
determining the reference point for one or more of the at least one of the first target content or the at least one second target content based on the identified priority order; and
positioning the cursor at the determined reference point based on the determined reference point corresponding to at least one of the first target content or the identified at least one second target content.

4. The method as claimed in claim 1, wherein controlling the cursor on the user interface comprises:
displaying one or more user options to the user for the identified at least one target content;
receiving a user selection to at least one of the one or more user options; and
controlling a position of the cursor such as to enable the user to select the identified at least one target content with the minimum number of user input subsequent to the received at least one user input.

5. The method as claimed in claim 1, wherein the navigation pattern is identified based on at least one of previous usage patterns of the user interface by the user, user browsing information, a current time zone, language preference of the user, and content feedback by the user, wherein the previous usage patterns of the user include at least user behavior towards a plurality of contents.

6. A system for controlling a cursor on a user interface, the system comprising:
a memory; and
at least one processor, communicably coupled with the memory, the at least one processor is configured to:
determine user context information based on at least current session information involving use related to the system by a user, a mood of the user, and an ambiance of an environment of the user;
acquire, based on the determined user context information, past usage data corresponding to the user, the past usage data including at least one of a navigation pattern of the user, a browsing history, and a usage pattern of a plurality of other users from a database;
identify a plurality of target contents for the user based on at least one of the determined user context information and the acquired past usage data corresponding to the user;
receive at least one user input indicating a direction of the cursor;
determining a current position of the cursor on the user interface;
identify at least one target content among the plurality of target contents based on the determined current position of the cursor on the user interface and the direction of the cursor indicated by the received at least one user input; and
control the cursor on the user interface that the cursor on the user interface is useable to enable the user to select the identified at least one target content using a minimum number of user input subsequent to the received at least one user input.

7. The system as claimed in claim 6, wherein the at least one target content is at least one first target content and the at least one processor is configured to:
identify at least one second target content among the plurality of target contents based on the determined current position of the cursor and the direction of the cursor indicated by the received at least one user input;
identify a region on the user interface corresponding to the identified at least one first target content and the identified at least one second target content;
determine, based on position coordinates of the identified at least one first target content and the identified at least one second target content, respectively, a reference point in the identified region from which the minimum number of user input subsequent to the received at least one user input is required to respectively select the at least one first target content and the at least one second target content; and
position the cursor at the determined reference point.

8. The system as claimed in claim 7, wherein the at least one processor is configured to:
identify a user appreciation degree corresponding to the plurality of target contents, respectively, for the user based on at least one of the determined user context information and the acquired past usage data;
determine a priority order of the plurality of target contents by prioritizing at least one of the first target content or the at least one second target content among the plurality of target contents based on the identified user appreciation degree;
determine the reference point for one or more of the at least one first target content or the at least one second target content based on the identified priority order; and
position the cursor at the determined reference point based on the determined reference point corresponding to at least one of the first target content or the identified at least one second target content.

9. The system as claimed in claim 6, wherein the at least one processor is configured to:
display one or more user options to the user for the identified at least one target content;
receive a user selection to at least one of the one or more user options; and
control a position of the cursor such as to enable the user to select the identified at least one target content with the minimum number of user input subsequent to the received at least one user input.

10. The system as claimed in claim 6, wherein the navigation pattern is identified based on at least one of a previous usage patterns of the user interface by the user, user browsing information, a current time zone, language preference of the user, and content feedback by the user, wherein the previous usage patterns of the user include at least user behavior towards a plurality of contents.
